(19) United States
(12) Patent Application Publication
(10) Pub. No.: US 2004/0190783 A1
(43) Pub. Date: Sep. 30, 2004

(54) Image compressing method, program, storing medium, and apparatus

(75) Inventors: Kenichiro Sakai, Kawasaki (JP); Tsugio Noda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/787,152

(22) Filed: Feb. 27, 2004

(30) Foreign Application Priority Data
Mar. 31, 2003 (JP) 2003-093555

(51) Int. Cl. G06K 9/36

(52) U.S. Cl. 382/232

(57) ABSTRACT

A first area separating unit scans bit map data in the main scanning direction and separates it into an area including black pixels and an area including no black pixel on a unit basis of logic rows as an integer of 1 or more. A first encoding unit encodes the area including no black pixel obtained by the first area separating unit. A second area separating unit scans the logic row including the black pixels separated by the first area separating unit in the sub-scanning direction and separates it into an area including black pixels and an area including no black pixel on a column unit basis. A second encoding unit encodes the area including the black pixels which was separated by the second area separating unit and in which the number of continuous columns is equal to or more than 2. A third area separating unit separates an area which coincides with a predetermined reference pattern in which the number of columns is equal to 1 from the areas which were not encoded by the second encoding unit. A third encoding unit encodes the area which coincides with the reference pattern and was separated by the third area separating unit.

### BACKGROUND OF THE INVENTION

1. Field of the Invention

The invention relates to an image compressing method, a program, a storing medium, and an apparatus for directly transferring a compressed bit map image to a printer which does not have any font and printing and, more particularly, to an image compressing method, a program, a storing medium, and an apparatus for efficiently compressing an image including an area containing black pixels in which the number of columns is equal to 1.

2. Description of the Related Arts

As conventional compressing methods of a bit map image, there are MH (Modified Huffman), MR (Modified READ), MMR (Modified Modified READ), JBIG (Joint Bi-Level Image Experts Group), and the like and they are widely used for FAX communication and image filing.

Since those compressing methods are not suitable for a high-speed encoding process because many bit processes are used or the like, a compressing method and a compressing apparatus of bit map data which intends to realize a high-speed process have been proposed (refer to the Official Gazette of Japanese Patent No. 3278298).

According to such an image compressing method, as shown in FIG. 1A, an input image 142 is scanned in the horizontal direction, areas 146-1 and 146-2 including black pixels are separated, the separated images are scanned in the vertical direction as shown in FIG. 1B, and areas 152-1 to 152-3 including black pixels are separated. An area 144-1 including no black pixel in FIG. 1A is encoded as a skip 148 in the vertical and horizontal directions. Areas 150-1 and 150-2 including no black pixel are encoded as skips 151-1 and 151-2 in the horizontal direction.

In the separated areas 152-1 to 152-3 including the black pixels, a same column pattern 154 in which columns having the same pixel value continue is encoded on the basis of the pixel value of the column and the number of repeating times and the other portion is regarded as a non-compression area which cannot be compressed and the pixel value is encoded and outputted as it is.

Further, to improve a compression ratio of the separated areas 152-1 to 152-3 including the black pixels as shown in FIG. 1B, there have been proposed: a method of compressing a stairway-like pattern 156 in which the pixel value of the column changes like a stairway (Japanese Patent Application No. 2001-397714); a method of compressing a repetitive pattern 158 in which a pattern of predetermined column and width appears continuously and repetitively (Japanese Patent Application No. 2001-388931); and, further, a method of compressing the same pattern which appears discretely (Japanese Patent Application No. 2001-397715). The area which remains after those image compressing methods were applied is regarded as a non-compression area which cannot be compressed, a type code word indicative of the non-compression is added to the pixel value, and the resultant pixel value is encoded and outputted as it is.

According to such conventional image compressing methods, however, when the non-compression area which could not be compressed is encoded and outputted, it is necessary to add the type code word indicative of the non-compression in order to distinguish such a code from other codes, so that a data amount is increased more than an original data size.

For example, when non-compression areas 160-1 to 160-5 remain as shown in FIG. 1C, assuming that the non-compression area including the black pixels of one column is set to 1 byte and the type code word indicative of the non-compression is set to 1 byte, in code data in FIG. 1D, since the type code word of one byte is added, 1 byte is changed to 2 bytes and continuous 2 bytes are changed to 3 bytes. Although the data before the encoding consists of 5 bytes, when it is encoded to the code data, the number of bytes is increased to 9 bytes.

With respect to the non-compression areas as shown in FIG. 1C, generally, the smaller the number of columns is, the higher a frequency of appearance is and there is a tendency such that the frequency of appearance of the area in which the number of columns is equal to 1 is assumed to be maximum and the frequency of appearance decreases in accordance with an increase in number of columns. There is, consequently, a problem such that a code size of the non-compression area in which the number of columns is equal to 1 and the frequency of appearance is maximum is increased two times by adding the type code word and encoding efficiency decreases remarkably.

### SUMMARY OF THE INVENTION

According to the invention, there are provided a compressing method, a program, a storing medium, and an apparatus which improve encoding efficiency of a non-compression area in which the number of columns is equal to 1 and which appears at a high frequency.

The invention provides an image compressing method. This image compressing method comprises:

a first area separating step wherein by scanning bit map data in a main scanning direction, the data is separated into an area including black pixels and an area including no black pixel on a unit basis of logic rows of a predetermined number as an integer of 1 or more by a first area separating unit 18;

a first encoding step wherein the area including no black pixel separated by the first area separating step is encoded as an element by a first encoding unit 20;

a second area separating step wherein by scanning the logic row including the black pixels separated by the first area separating step in a sub-scanning direction which crosses the main scanning direction, the data is separated into an area including the black pixels and an area including no black pixel on a column unit basis by a second area separating unit 22;

a second encoding step wherein the area including the black pixels which was separated by the second area separating step and in which the number of continuous columns is equal to or more than 2 is selected and encoded by a second encoding unit 24;

a third area separating step wherein an area which coincides with a predetermined reference pattern in which the number of columns is equal to 1 is separated by a third area separating unit 26 from the areas which were not encoded in the second encoding step; and

a third encoding step wherein the area which coincides with the reference pattern and was separated by the third area separating step is encoded by a third encoding unit 28.

As mentioned above, according to the invention, an attention is paid to a feature such that the image is scanned in the main scanning (horizontal) direction and separated into the area including the black pixels and the area including no black pixel, the area including the black pixels is further scanned in the sub-scanning (vertical) direction and separated into the area including the black pixels and the area including no black pixel, and when each of the separated areas is encoded as an element, with respect to the areas remaining as non-compression areas, the smaller the number of columns is, the higher the frequency of appearance is and the frequency of appearance of the area in which the number of columns is equal to 1 becomes maximum, and by allocating a code to the image in which the frequency of appearance is highest and the number of columns is equal to 1 among the non-compression areas, the area which has conventionally been outputted without being compressed is encoded and compressed, thereby raising a compression ratio.

The reference pattern which is separated in order to encode the non-compression area including the black pixels in which the number of columns is equal to 1 and which comprises a plurality of kinds of patterns of a predetermined number selected in order of the pattern whose frequency of appearance is high among the areas including the black pixels in which the number of columns is equal to 1 and which remain without being encoded by the second encoding step. In the third encoding step, the area including the black pixels in which the number of columns is equal to 1 and which was separated in the third area separating step is encoded by using a code showing a pattern number of the coincident reference pattern and a code showing a code type.

As a reference pattern which is compared with the non-compression area of one column, if the pattern whose frequency of appearance is high has already been known, a known pattern can be used. However, since there are a variety of input images and their features are also different, there is a possibility that the optimum pattern exists every image. Therefore, the frequency of appearance of the non-compression area of one column obtained from the input image is obtained upon encoding and the pattern whose frequency of appearance is high is dynamically selected from the patterns and determined as a reference pattern, so that the reference pattern which is suitable to raise the encoding efficiency can be selected every image.

Naturally, the reference pattern can be a plurality of kinds of known patterns of a predetermined number which have been selected in order of the pattern whose frequency of appearance is high with respect to the areas including the black pixels in which the number of columns is equal to 1 and have previously and statistically been obtained with respect to the area including the black pixels in which the number of columns is equal to 1 and which is separated in the third area separating step.

The reference pattern is a pattern in which one or a plurality of black pixels in one column are continuously included and in the third encoding step, the area including the black pixels in which the number of columns is equal to 1 and which was separated in the third area separating step can be also encoded by using a code showing positions of the black pixels in one column of the coincident reference pattern and the number of continuous black pixels and a code showing a code type.

The general frequency of appearance of the pixel pattern in which the number of columns is equal to 1 has a feature such that the frequency of appearance of the pattern including only one black pixel is maximum and the frequency of appearance of the pattern including two or more adjacent black pixels is the second highest. From this feature, the area including the black pixels in which the number of columns is equal to 1 is encoded by using a code showing the number of continuous black pixels and the positions of the black pixels, thereby further raising the compression ratio.

The reference pattern is narrowed down to a pattern in which one black pixel in one column is included and in the third encoding step, the area including the black pixels in which the number of columns is equal to 1 and which was separated in the third area separating step can be also encoded by using a code showing positions of the black pixels in one column of the coincident reference pattern and a code showing a code type.

Such a construction is suitable in the case where there is not a surplus of bits which are allocated to the code showing the number of plural continuous black pixels and the positions thereof. Only the pattern including only one black pixel is encoded. Also in this case, generally, since the frequency of appearance of the pattern including only one black pixel in the area in which the number of columns is equal to 1 is maximum, a sufficient compressing effect is obtained although it deteriorates in the case of encoding a plurality of continuous black pixels.

Further, if there is a surplus of code bits showing the copy type, the reference pattern is set to a pattern in which one or a plurality of black pixels in one column are included and in the third encoding step, the area including the black pixels in which the number of columns is equal to 1 and which was separated in the third area separating step can be also encoded by using a code showing positions of the black pixels in one column and a code showing the number of continuous black pixels and a code type.

In the first encoding step, the area including no black pixel obtained in the first area separating step is encoded by the number of rows which are skipped, and in the second encoding step, the area including no black pixel obtained in the second area separating step is encoded by the number of columns which are skipped, and the area including the black pixels of two or more continuous columns separated in the second area separating step is separated into a same column pattern, a stairway-like pattern, and a repetitive pattern and encoded, respectively.

According to another embodiment of an image compressing method of the invention, the method comprises:

a first area separating step wherein by scanning bit map data in a main scanning direction, the data is separated into an area including black pixels and an area including no black pixel on a unit basis of logic rows of a predetermined number as an integer of 1 or more by a first area separating unit 18;

a second area separating step wherein by scanning the logic row including the black pixels separated by the first area separating step in a sub-scanning direction which crosses the main scanning direction, the data is separated into an area including black pixels and an area including no black pixel on a column unit basis by a second area separating unit 22;

a third area separating step wherein an area which coincides with a predetermined reference pattern in which the number of columns is equal to 1 is separated by a third area separating unit 26 from the areas including the black pixels in which the number of columns is equal to 1 and which were separated in the second area separating step; and

an encoding step wherein each of the areas separated by the first to third area separating steps is encoded as an element by an encoding unit.

The invention provides a program for compressing an image. This program allows a computer to execute:

a first area separating step wherein by scanning bit map data in a main scanning direction, the data is separated into an area including black pixels and an area including no black pixel on a unit basis of logic rows of a predetermined number as an integer of 1 or more;

a first encoding step wherein the area including no black pixel separated by the first area separating step is encoded as an element;

a second area separating step wherein by scanning the logic row including the black pixels separated by the first area separating step in a sub-scanning direction which crosses the main scanning direction, the data is separated into an area including black pixels and an area including no black pixel on a column unit basis;

a second encoding step wherein the area including the black pixels which was separated by the second area separating step and in which the number of continuous columns is equal to or more than 2 is encoded as an element;

a third area separating step wherein an area which coincides with a predetermined reference pattern in which the number of columns is equal to 1 is separated from the areas which were not encoded in the second encoding step; and

a third encoding step wherein the area which coincides with the reference pattern and was separated by the third area separating step is encoded.

As another embodiment of a program for compressing an image according to the invention, the program allows a computer to execute:

a first area separating step wherein by scanning bit map data in a main scanning direction, the data is separated into an area including black pixels and an area including no black pixel on a unit basis of logic rows of a predetermined number as an integer of 1 or more;

a second area separating step wherein by scanning the logic row including the black pixels separated by the first area separating step in a sub-scanning direction which crosses the main scanning direction, the data is separated into an area including black pixels and an area including no black pixel on a column unit basis;

a third area separating step wherein an area which coincides with a predetermined reference pattern in which the number of columns is equal to 1 is separated from the areas including the black pixels in which the number of columns is equal to 1 and which were separated in the second area separating step; and

an encoding step wherein each of the areas separated by the first to third area separating steps is encoded as an element.

The invention provides a computer-readable storing medium which stores a program for compressing an image. This storing medium stores a program for allowing a computer to execute:

a first area separating step wherein by scanning bit map data in a main scanning direction, the data is separated into an area including black pixels and an area including no black pixel on a unit basis of logic rows of a predetermined number as an integer of 1 or more;

a first encoding step wherein the area including no black pixel separated by the first area separating step is encoded as an element;

a second area separating step wherein by scanning the logic row including the black pixels separated by the first area separating step in a sub-scanning direction which crosses the main scanning direction, the data is separated into an area including black pixels and an area including no black pixel on a column unit basis;

a second encoding step wherein the area including the black pixels which was separated by the second area separating step and in which the number of continuous columns is equal to or more than 2 is encoded as an element;

a third area separating step wherein an area which coincides with a predetermined reference pattern in which the number of columns is equal to 1 is separated from the areas which were not encoded in the second encoding step; and

a third encoding step wherein the area which coincides with the reference pattern and was separated by the third area separating step is encoded.

According to another embodiment of the invention provides a computer-readable storing medium which stores a program for compressing an image. This storing medium stores a program for allowing a computer to execute:

a first area separating step wherein by scanning bit map data in a main scanning direction, the data is separated into an area including black pixels and an area including no black pixel on a unit basis of logic rows of a predetermined number as an integer of 1 or more;

a second area separating step wherein by scanning the logic row including the black pixels separated by the first area separating step in a sub-scanning direction which crosses the main scanning direction, the data is separated into an area including black pixels and an area including no black pixel on a column unit basis;

a third area separating step wherein an area which coincides with a predetermined reference pattern in which the number of columns is equal to 1 is separated from the areas including the black pixels in which the number of columns is equal to 1 and which were separated in the second area separating step; and

an encoding step wherein each of the areas separated by the first to third area separating steps is encoded as an element.

The invention provides an image compressing apparatus. This image compressing apparatus comprises: a first area separating unit 18 which scans bit map data in a main scanning direction, thereby separating the data into an area including black pixels and an area including no black pixel on a unit basis of logic rows of a predetermined number as an integer of 1 or more; a first encoding unit 20 which encodes the area including no black pixel separated by the first area separating unit 18 as an element; a second area separating unit 22 which scans the logic row including the black pixels separated by the first area separating unit 18 in a sub-scanning direction which crosses the main scanning direction, thereby separating the data into an area including black pixels and an area including no black pixel on a column unit basis; a second encoding unit 24 which encodes the area, as an element, including the black pixels which was separated by the second area separating unit 22 and in which the number of continuous columns is equal to or more than 2; a third area separating unit 26 which separates an area which coincides with a predetermined reference pattern in which the number of columns is equal to 1 from the areas which were not encoded by the second encoding unit 24; and a third encoding unit 28 which encodes the area which coincides with the reference pattern and was separated by the third area separating unit 26.

According to another embodiment of an image compressing apparatus of the invention, the apparatus comprises: a first area separating unit which scans bit map data in a main scanning direction, thereby separating the data into an area including black pixels and an area including no black pixel on a unit basis of logic rows of a predetermined number as an integer of 1 or more; a second area separating unit which scans the logic row including the black pixels separated by the first area separating unit in a sub-scanning direction which crosses the main scanning direction, thereby separating the data into an area including black pixels and an area including no black pixel on a column unit basis; a third area separating unit which separates an area which coincides with a predetermined reference pattern in which the number of columns is equal to 1 from the areas including the black pixels in which the number of columns is equal to 1 and which were separated by the second area separating unit; and an encoding unit which encodes each of the areas separated by the first to third area separating units as an element.

Details of the programs, storing media, and image storing apparatuses according to the invention are fundamentally the same as the image compressing methods.

The above and other objects, features, and advantages of the present invention will become more apparent from the following detailed description with reference to the drawings.

### BRIEF DESCRIPTION OF THE DRAWINGS

FIGS. 1A to 1D are explanatory diagrams of an image compressing process for encoding an area including black pixels in which the number of columns is equal to 1 as a non-compression area;

FIG. 2 is a block diagram of a functional construction showing an embodiment of the invention;

FIG. 3 is an explanatory diagram of a hardware environment of a computer to which the invention is applied;

FIGS. 4A to 4D are explanatory diagrams of a compressing process of a bit map image according to the invention;

FIGS. 5A to 5C are explanatory diagrams of a code word at the time of separating an area including black pixels of two or more columns and encoding by the process in FIGS. 4A to 4D;

FIG. 6 is a graph showing a relation between the number of columns of a non-compression area and a frequency of appearance;

FIG. 7 is a distribution diagram showing a relation between a pixel value of the non-compression area in which the number of columns is equal to 1 and the frequency of appearance;

FIG. 8 is an explanatory diagram of a reference pattern file in which reference patterns have been registered in order of the high frequency of appearance;

FIG. 9 is a flowchart showing the first embodiment of the image compressing process of the invention using the reference pattern file of FIG. 8;

FIG. 10 is an explanatory diagram of a code word for separating the area including the black pixels in which the number of columns is equal to 1 and encoding by the coincident reference pattern by the process in FIG. 9;

FIG. 11 is a flowchart showing the second embodiment of an image compressing process of the invention:

FIG. 12 is an explanatory diagram of a code word for separating the area including the black pixels in which the number of columns is equal to 1 and encoding by the process in FIG. 11;

FIGS. 13A to 13D are explanatory diagrams of designated information of black pixel positions according to the number of black pixels which are used in the code word in FIG. 12;

FIG. 14 is an explanatory diagram of another code word for separating the area including the black pixels in which the number of columns is equal to 1 and encoding by the process in FIG. 11;

FIG. 15 is an explanatory diagram of designated information of black pixel positions which are used in the code word in FIG. 14;

FIGS. 16A and 16B are explanatory diagrams of another code word for separating the area including the black pixels in which the number of columns is equal to 1 and encoding by the process in FIG. 11; and

FIGS. 17A and 17B are explanatory diagrams of designated information of black pixel positions in which the number of black pixels which are used in the code word in FIGS. 16A and 16B is set to a type code.

### DETAILED DESCRIPTION OF THE PREFERRED EMBODIMENTS

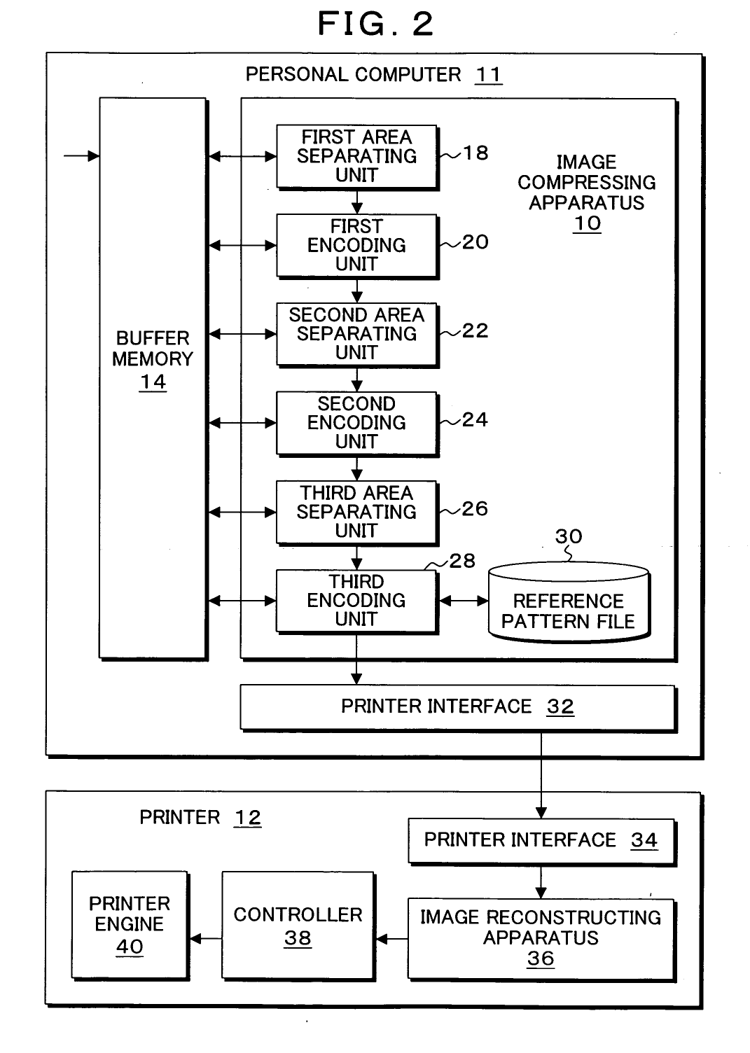

FIG. 2 is a block diagram of a functional construction showing an embodiment of an image compressing apparatus according to the invention. An image compressing apparatus 10 of the invention is realized as a function by executing a program in a personal computer 11. An image reconstructing apparatus 36 is provided for a printer 12 side in correspondence to the image compressing apparatus 10 of the invention.

The image compressing apparatus 10 inputs binary bit map data, as image data, formed by the personal computer 11 in order to print, compresses the image data, and transfers it to the printer 12. The printer 12 is a printer having no font. The printer 12 receives a bit map image which is directly transferred from the personal computer 11 and prints it.

A buffer memory 14 is provided for the image compressing apparatus 10 of the invention. The binary bit map data which is transferred to the printer 12 is held in the buffer memory 14. Encoding data compressed by the image compressing apparatus 10 is transferred from a printer interface 32 to the printer 12, received by a printer interface 34 of the printer 12, and reconstructed to the original binary bit map data by the image reconstructing apparatus 36. The bit map data reconstructed by the image reconstructing apparatus 36 is sent from a controller 38 to a printer engine 40 and the printing operation is executed.

The image compressing apparatus 10 on the personal computer 11 side is provided with: a first area separating unit 18; a first encoding unit 20; a second area separating unit 22; a second encoding unit 24; a third area separating unit 26; a third encoding unit 28; and further, a reference pattern file 30.

The first area separating unit 18 scans the bit map data held in the buffer memory 14 in the main scanning direction (horizontal direction), thereby separating the data into an area including black pixels and an area including no black pixel on a unit basis of logic rows of K rows as an integer of 1 or more. The first encoding unit 20 encodes the area including no black pixel separated by the first area separating unit 18 as an element.

The second area separating unit 22 scans the logic row including the black pixels separated by the first area separating unit 18 in a sub-scanning direction (vertical direction) which crosses the main scanning direction, thereby separating the data into an area including black pixels and an area including no black pixel on a column unit basis. The second encoding unit 24 encodes the area, as an element, including the black pixels in which the number of continuous columns is equal to or larger than 2 and which was separated by the second area separating unit 22.

The third area separating unit 26 separates an area which coincides with a reference pattern in which the number of columns is equal to 1 registered in the predetermined reference pattern file 30 from the areas including the black pixels which were not encoded by the second encoding unit 24. The third encoding unit 28 encodes the area which coincides with the reference pattern and was separated by the third area separating unit 26.

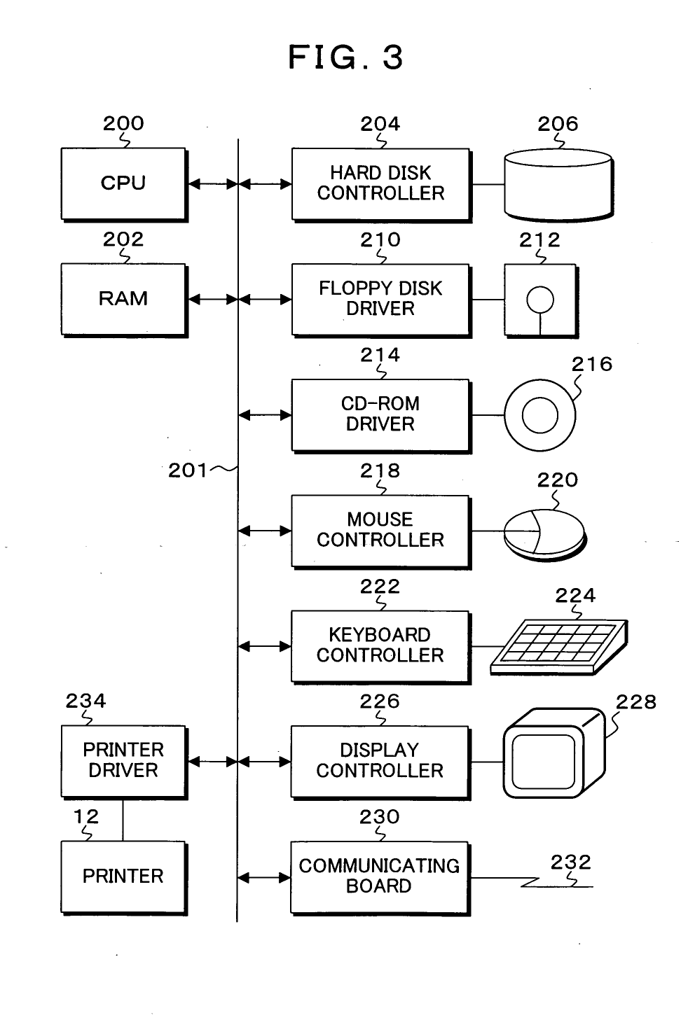

The personal computer having the functions of the image compressing apparatus of the invention in FIG. 2 is realized by, for example, hardware resources of a computer as shown in FIG. 3.

In the computer in FIG. 3, a RAM 202, a hard disk controller (software) 204, a floppy disk driver (software) 210, a CD-ROM driver (software) 214, a mouse controller 218, a keyboard controller 222, a display controller 226, a board 230 for communication, and a printer driver 234 are connected to a bus 201 of a CPU 200.

A hard disk drive 206 is connected to the hard disk controller 204 and an application program to execute an image compressing process of the invention has been loaded therein. When the computer is activated, the hard disk controller 204 calls a necessary program from the hard disk drive 206, develops it into the RAM 202, and executes it by the CPU 200, thereby making image compression in the printer driver 234.

A floppy disk drive (hardware) 212 is connected to the floppy disk driver 210 and the reading and writing from/into a floppy disk (R) can be performed. A CD drive (hardware) 216 is connected to the CD-ROM driver 214 and data and programs stored in a CD can be read. The mouse controller 218 transfers the inputting operation of a mouse 220 to the CPU 200.

The keyboard controller 222 transfers the inputting operation of a keyboard 224 to the CPU 200. The display controller 226 controls a display unit 228 so as to display. The communicating board 230 communicates with another computer or server via a network such as Internet or the like by using a communicating line 232.

The printer driver 234 transfers code data which was image compressed by the image compressing apparatus of the invention to the printer 12, reconstructs the code data provided for the printer 12 side, and allows the printer to print.

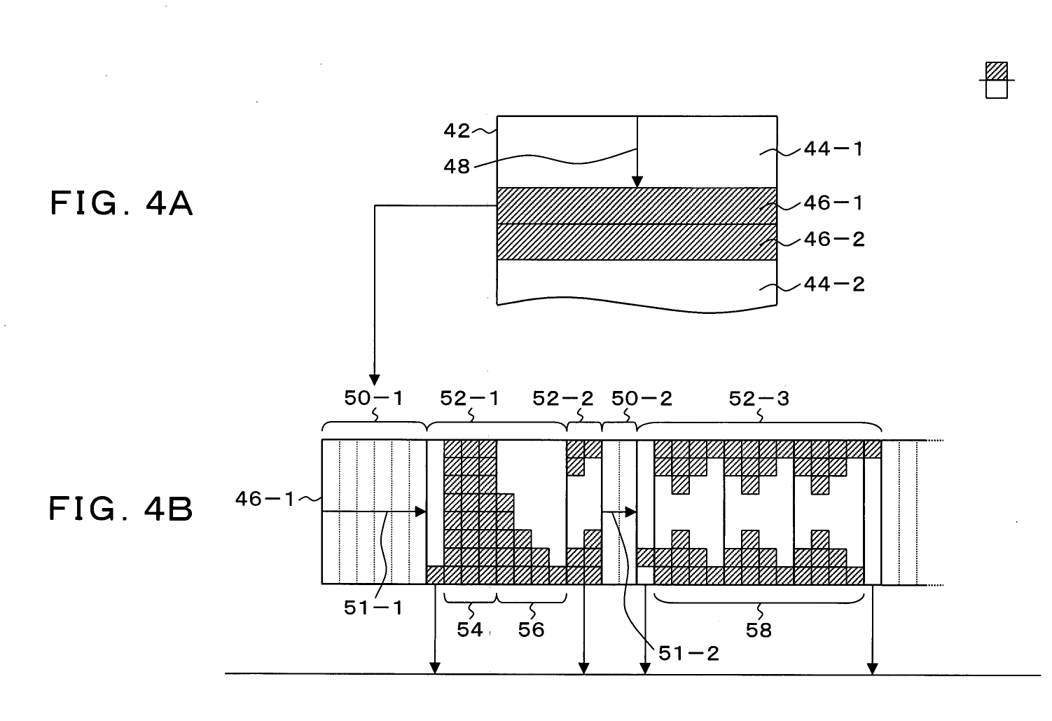

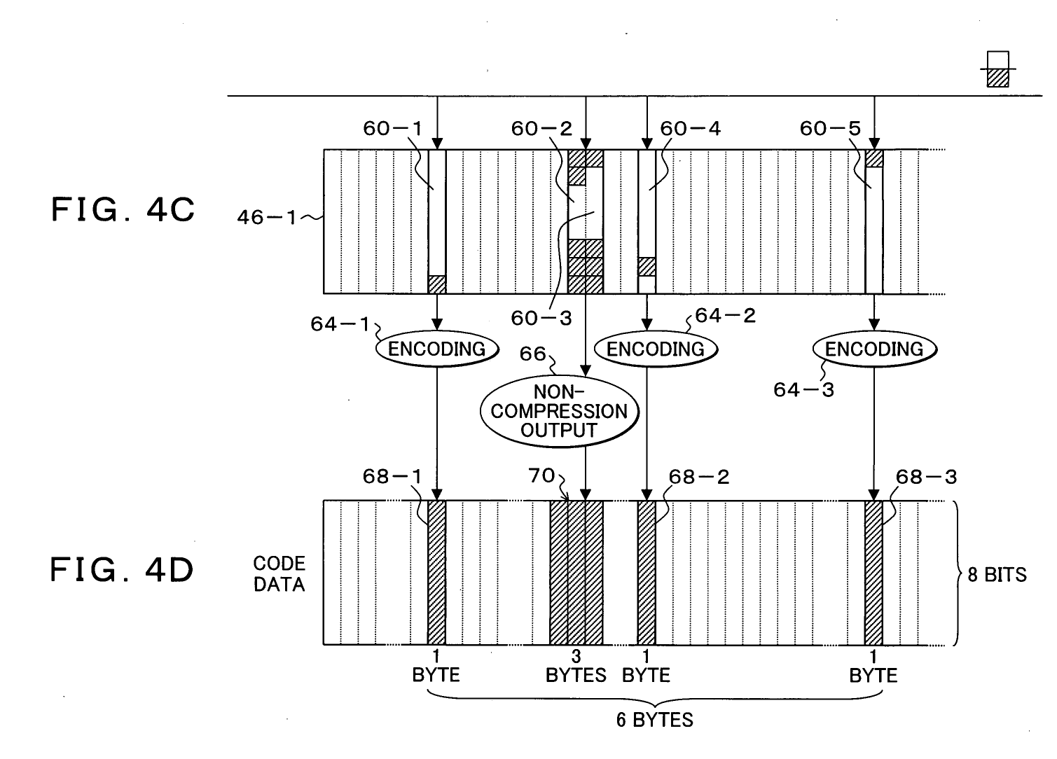

FIGS. 4A to 4D are explanatory diagrams of a compressing process of a bit map image by the image compressing apparatus 10 of the invention. In the image compressing process of the invention, as shown in FIG. 4A, an input image 42 is scanned in the main scanning direction (horizontal direction), thereby separating the image into areas 44-1 and 44-2 including no black pixel and areas 46-1 and 46-2 including black pixels on a unit basis of logic rows as an integer K of 1 or more.

The case where K=8 lines are used as logic rows is explained in this example. In the areas 44-1 and 44-2 including no black pixel which were separated by scanning the input image 42 in the main scanning direction, for example, as shown with respect to the area 44-1, it is encoded as a skip 48 in the vertical direction.

Subsequently, in the areas 46-1 and 46-2 including the black pixels which were separated by scanning the input image 42 in the main scanning direction, for example, in the case of the area 46-1, the area 46-1 including the black pixels which is given as logic rows as shown in FIG. 4B is scanned in the sub-scanning direction (vertical direction) which crosses the main scanning direction and separated into areas 50-1 and 50-2 including no black pixel and areas 52-1 to 52-3 including black pixels. The areas 50-1 and 50-2 and the areas 52-1 to 52-3 are encoded as elements.

Upon encoding, the areas 50-1 and 50-2 including no black pixel are encoded as skips 51-1 and 51-2 in the horizontal direction. The areas 52-1 to 52-3 including the black pixels are separated into areas of a same column pattern 54, a stairway-like pattern 56, and a repetitive pattern 58 and those areas are encoded as elements.

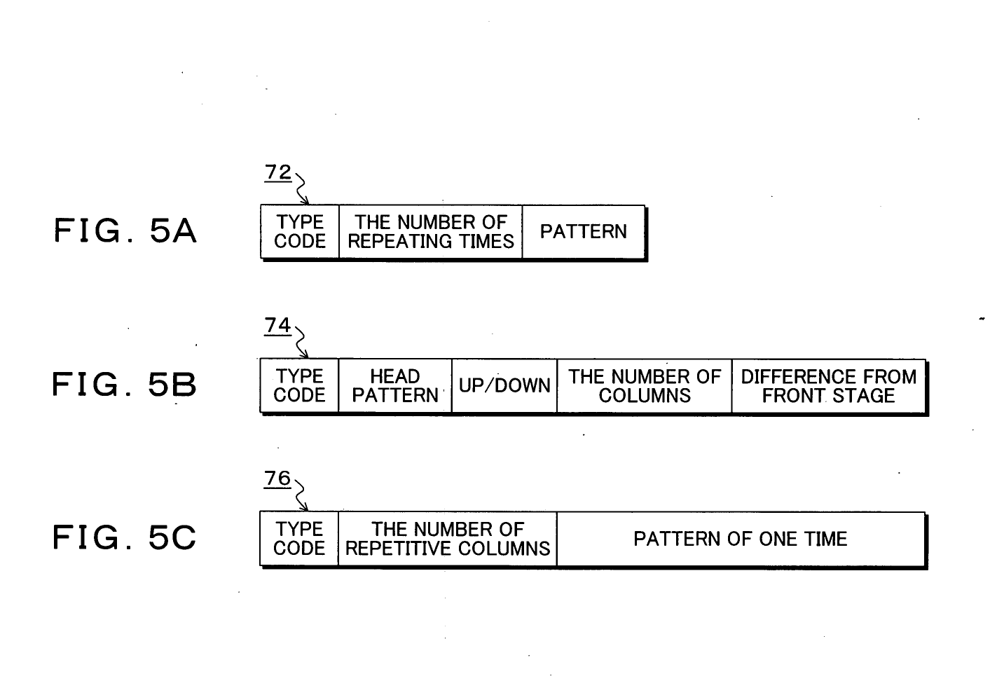

That is, the same column pattern 54 is encoded by a type code showing the same column pattern, the number of repeating times of the column, and a pattern of one column as shown in a code word 72 in FIG. 5A. The stairway-like pattern 56 is encoded by a type code showing the stairway-like pattern, a head pattern regarding one head column, the number of up or down columns of the stairway, and a difference from the front stage as shown in a code word 74 in FIG. 5B. Further, the repetitive pattern 58 is encoded by a type code showing the repetitive pattern, the number of repetitive columns which are repeated, and a pattern of one time as shown in a code word 76 in FIG. 5C.

The encoding of the areas including the black pixels separated in the sub-scanning direction as mentioned above is the encoding process regarding the areas in which the number of columns is equal to or larger than 2. The portions which could not be compressed by the encoding so far remain as non-compression areas 60-1 to 60-5 as shown in FIG. 4C.

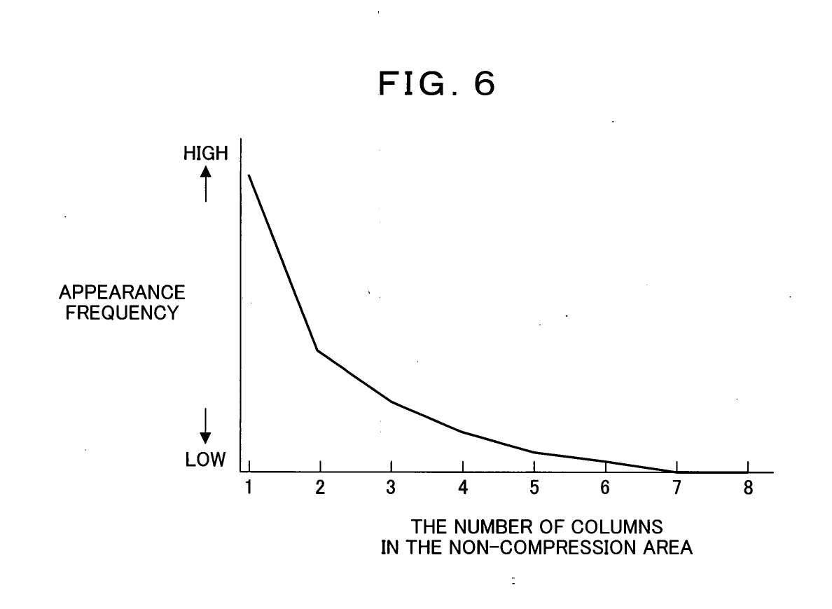

According to a study by the inventors of the present invention, a frequency of appearance of the number of columns remaining as non-compression areas. 60-1 to 60-5 as shown in FIG. 4C is as shown in FIG. 6. In FIG. 6, an axis of abscissa indicates the number of columns of the non-compression area and an axis of ordinate indicates the frequency of appearance. As will be obviously understood from characteristics of FIG. 6, the frequency of appearance of the number of columns of the non-compression area has a feature such that the smaller the number of columns is, the higher the frequency of appearance is, the frequency of appearance of the area in which the number of columns is equal to 1 is maximum, and the larger the number of columns is, the more the frequency of appearance decreases.

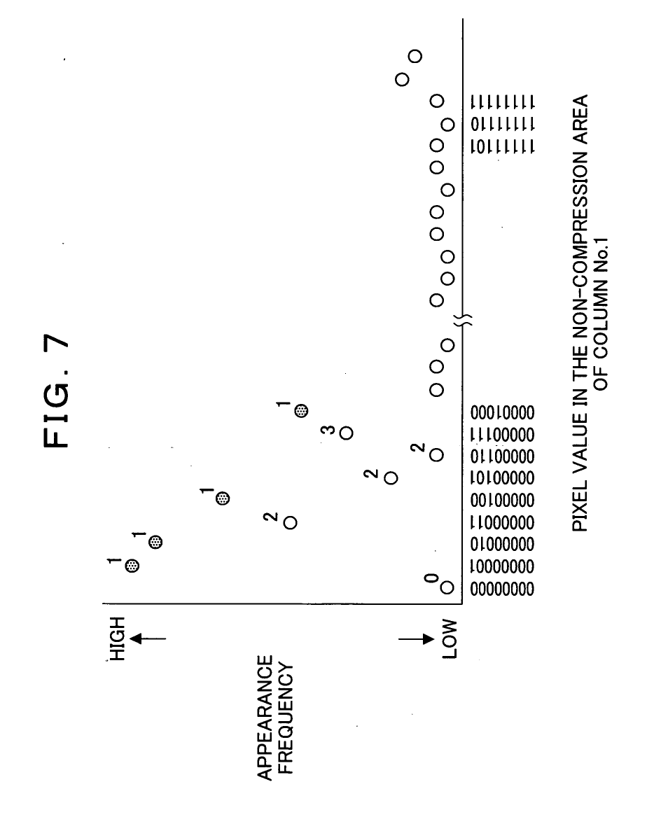

The frequency of appearance of the pixel pattern of the black pixels included in the area in which the-number of columns is equal to 1 and the frequency of appearance becomes maximum is as shown in FIG. 7. FIG. 7 shows the frequency of appearance to the pixel value of the non-compression area in which the number of columns is equal to 1 and which has an array of 8 bits. There is a feature such that the frequency of appearance of a certain specific pattern is high and a deviation exists in the frequency of appearance of the pattern. In FIG. 7, the number of black pixels corresponding to bit 1 in the pixel pattern is shown by a numeral beside a corresponding point of the frequency of appearance.

In the invention, an attention is paid to the features of the images of the non-compression areas in FIGS. 6 and 7 and by allocating a code to the image in which the number of columns is equal to 1 and the frequency of appearance is highest among the non-compression areas, the area which has been outputted in a non-compressing state is encoded and outputted, thereby improving a compression ratio.

As a reference pattern to be compared with the non-compression area of one column serving as a target of encoding, a known pattern can be fixedly used by statistically obtaining the pattern whose frequency of appearance is high. However, since there are a variety of input images and their features are different, there is a possibility that the optimum pattern exists every image.

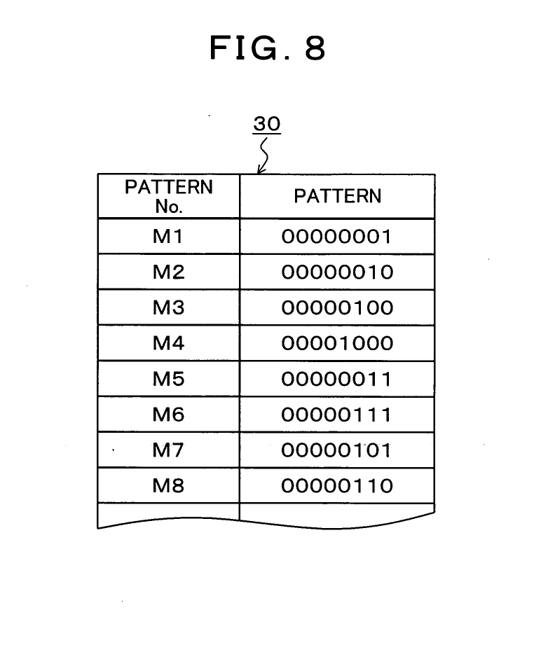

In the invention, therefore, when the non-compression area is encoded, the frequency of appearance of the non-compression area of one column obtained from the input image is obtained as shown in, for example, FIG. 8 and the pattern whose frequency of appearance is high is selected from the patterns and determined as a reference pattern, so that the reference pattern which is suitable to raise the encoding efficiency can be selected every image.

FIG. 8 shows an example of the reference pattern file 30 in which the reference patterns have been registered in order of the high frequency of appearance with respect to the frequency of appearance to the pixel value of the non-compression area in which the number of columns is equal to 1 in FIG. 7. The file is constructed by the pattern numbers and the patterns arranged in order of the high frequency of appearance. The number of patterns which are registered in the reference pattern file 30 is determined in accordance with the number of bits of the code word which can be allocated to the pattern number.

When seeing the frequency of appearance of the non-compression area in which the number of columns is equal to 1 in FIG. 7, the frequency of appearance of the pixel pattern in which the number of columns is equal to 1 has a feature such that the frequency of appearance of the pattern including only one black pixel is maximum and, subsequently, the frequency of appearance of the pattern including 2 or more continuous black pixels is high. Consequently, by encoding the non-compression area in which the number of columns is equal to 1 and which includes M (M is an integer of 1 or more) continuous black pixels by using the number N of black pixels and a code showing the position of the black pixel, the compression ratio can be further raised.

If there is no surplus for bits which are allocated to the code showing the positions where the N continuous black pixels exist, only the pattern including the black pixel of M=1, that is, only one black pixel can be encoded. Further, if there is a surplus for the type code showing the type of code, it is possible to prepare a type code including the number of black pixels, allocate only the code showing the positions of the black pixels to this type code, and encode the non-compression area. Specific examples of the encoding of those non-compression areas of one column will be further described in detail hereinafter.

Assuming that the encoding in which the pattern including one black pixel is set to the reference pattern has been performed with respect to, for example, the non-compression areas 60-1 to 60-5 in FIG. 4C by the encoding to the non-compression areas including the black pixels in which the number of columns is equal to 1 according to the invention as mentioned above, encoding processes 64-1, 64-2, and 64-3 are executed with respect to the non-compression areas 60-1, 60-4, and 60-5 and code words 68-1, 68-2, and 68-3 each consisting of 1 byte are obtained.

With respect to the non-compression areas 60-2 and 60-3, since they do not coincide with the reference pattern, they become a non-compression output 66. Since the code word of one byte showing the non-compression is added to it, the non-compression output 66 is set to 3 bytes.

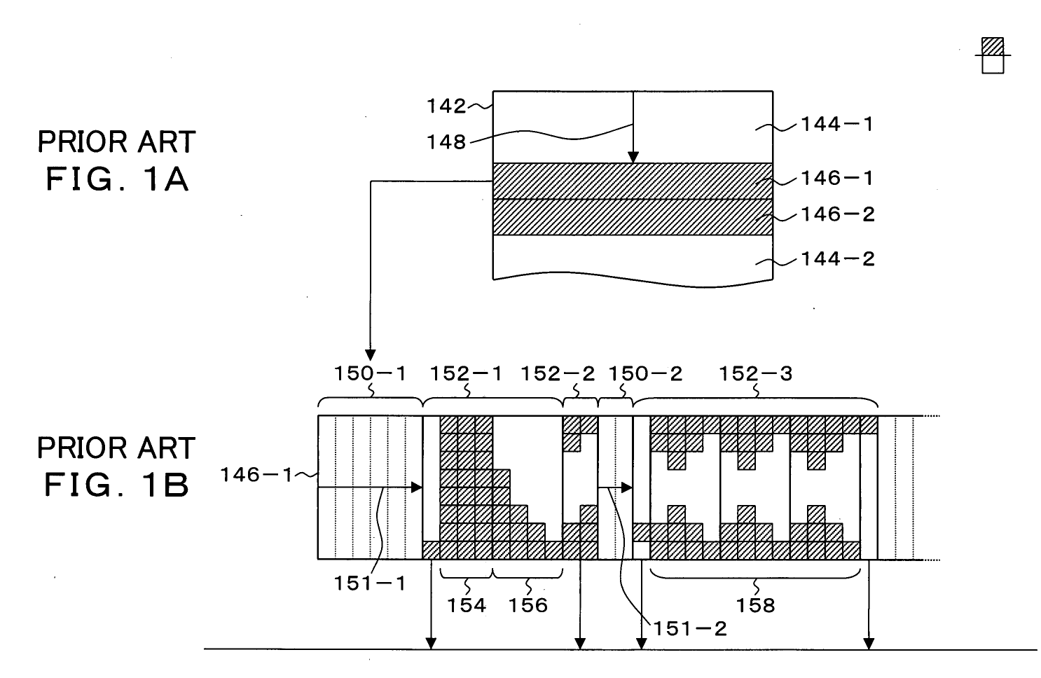

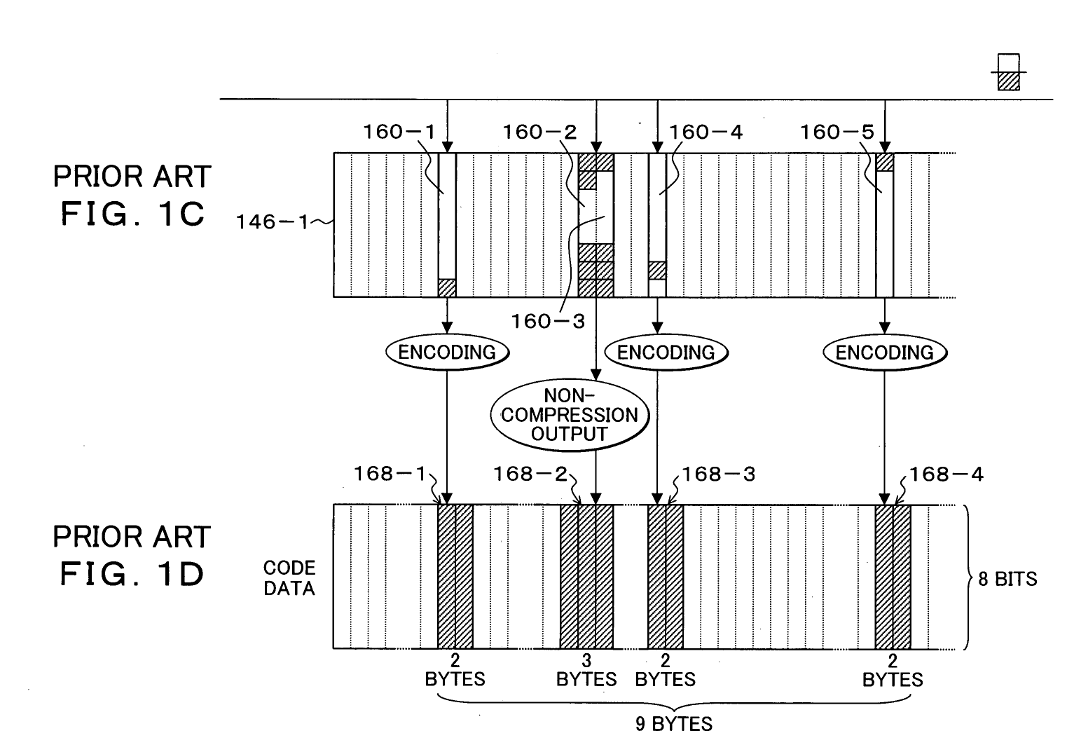

The input image 42 in FIGS. 4A to 4D is the same image data as the input image 142 in the prior art shown in FIGS. 1A to ID. In the code data of FIG. 1D, since all of the non-compression areas in FIG. 1C become the non-compression outputs, the code data according to the invention in FIG. 4D consists of 6 bytes although the original code data consists of 9 bytes. The compression ratio is fairly improved.

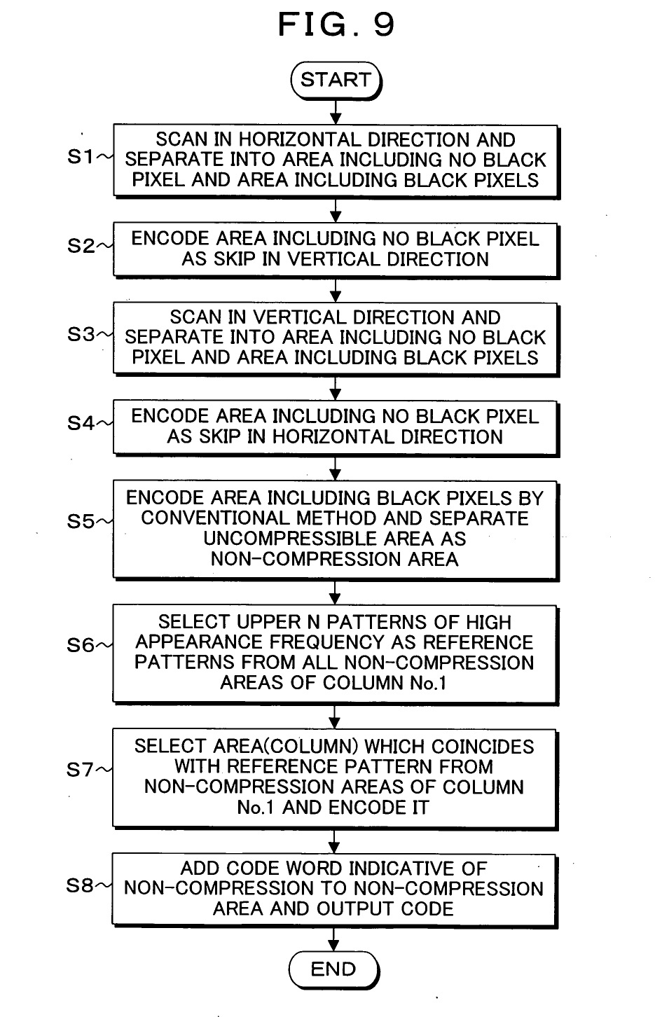

FIG. 9 is a flowchart in the first embodiment of the image compressing process according to the invention. The image compressing process is characterized by encoding by using the reference pattern whose frequency of appearance is high among the non-compression areas in which the number of columns is equal to 1. That is, the image compressing process in FIG. 9 will now be described as follows with reference to FIGS. 4A to 4D.

Step S1:

The input image 42 in FIG. 4A is scanned in the main scanning direction (horizontal direction) and separated into the areas 44-1 and 44-2 including no black pixel and the areas 46-1 and 46-2 including the black pixels. The separation by the scan in the main scanning direction is performed on a unit basis of the logic rows of K=8 lines or its multiple. By the scan in the main scanning direction, for example, in the case of a document image, the image is separated into a space between rows and rows including characters.

Step S2:

The areas 44-1 and 44-2 including no black pixel separated in step S1 are encoded as a skip 48 in the vertical direction as shown in, for example, the area 44-1 by using the number of lines including no black pixel.

Step S3:

The areas 46-1 and 46-2 including the black pixels separated in step Si are scanned in the sub-scanning direction, that is, the vertical direction which crosses the main scanning direction serving as a column unit as shown in, for example, the area 46-1 in FIG. 4B and separated into the areas 50-1 and 50-2 including no black pixel and the areas 52-1 to 52-3 including the black pixels. By performing such a scan, for example, in the case of a document image, it is separated into a space between characters and a character portion.

Step S4:

The areas 50-1 and 50-2 including no black pixel separated in step S3 are encoded as skips 51-1 and 51-2 in the horizontal direction by using the number of columns including no black pixel.

Step S5:

The areas 52-1 to 52-3 including the black pixels separated in step S3 are separated into compressible portions such as continuous same column pattern 54, stairway-like pattern 56, repetitive pattern 58, and the like and those portions are encoded. Portions which could not be compressed are separated as non-compression areas 60-1 to 60-5 as shown in FIG. 4C.

Step S6:

The frequencies of appearance of the image patterns of one column are counted, for example, as shown in FIG. 7 on a unit basis of the non-compression area in which the number of columns is equal to 1 among the non-compression areas 60-1 to 60-5 separated in step S5. Predetermined P patterns are selected in order of the pattern whose frequency of appearance is high and the reference patterns are set like a reference pattern file 30 in FIG. 8.

Step S7:

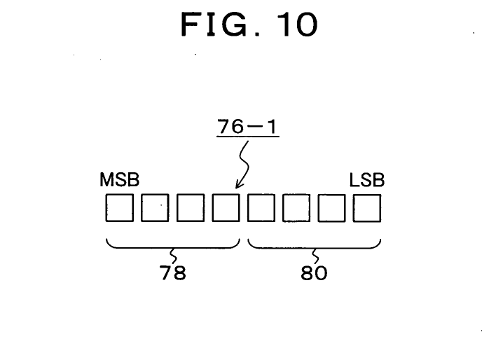

The reference patterns selected in step S6 are compared with the non-compression areas 60-1 to 60-5 in which the number of columns is equal to 1 and the area which coincides with one of the reference patterns is selected. The selected non-compression area in which the number of columns is equal to 1 is encoded, for example, by a code word 76-1 in FIG. 10 by using the number of the reference pattern. A type code 78 of 4 bits showing the type of code word and a reference pattern number 80 of 4 bits showing the number of the reference pattern are allocated to the code word 76-1 and 4 bits are allocated to the reference pattern number 80. Therefore, the code word 76-1 can encode by using 16 reference patterns. A bit length of the code which is allocated to the reference pattern number 80 in the code word 76-1 is determined in consideration of a length of bits to be allocated to other codes.

Step S8:

A code word showing the non-compression area is added to the non-compression areas in which the number of columns is equal to 1 and which were not encoded in step S7 and the non-compression areas in which the number of columns is equal to or larger than 2 and the resultant non-compression areas are outputted as code data.

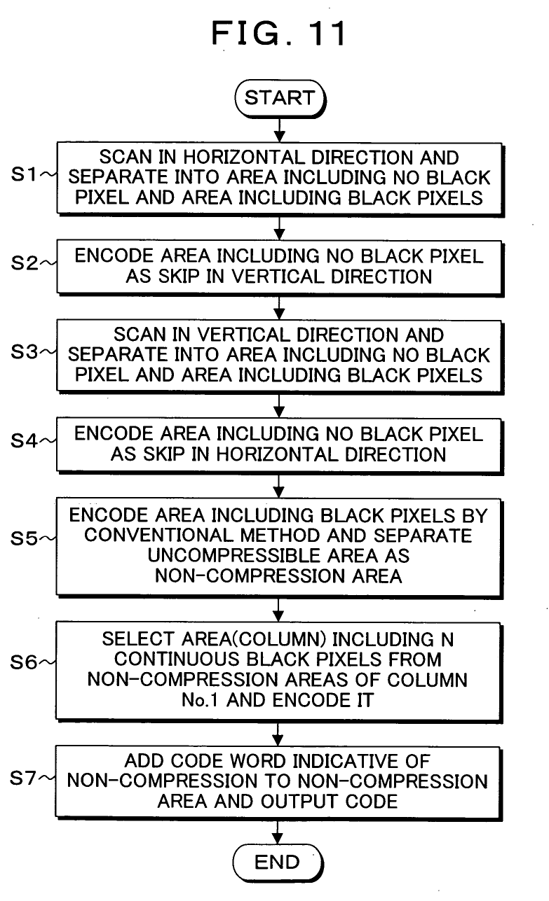

FIG. 11 is a flowchart showing the second embodiment of an image compressing process of the invention. This embodiment is characterized by encoding by using the pattern including the continuous black pixels among the non-compression areas in which the number of columns is equal to 1 as a reference pattern.

In FIG. 11, processes in steps S1 to S5 and S7 are the same as those in steps S1 to S5 and S8 in FIG. 9. In a process in step S6 in FIG. 11, with respect to the non-compression area in which the number of columns is equal to 1 among the non-compression areas separated in step S5, the column in which 1 to N black pixels continue is selected.

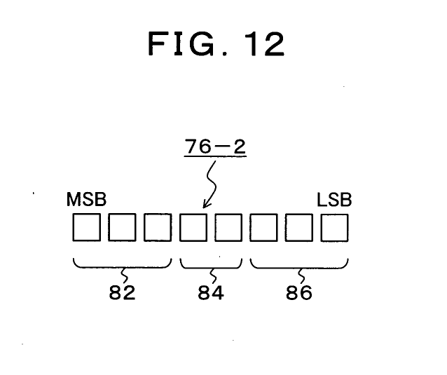

The selected non-compression area in which the number of columns is equal to 1 is encoded, for example, by a code word 76-2 in FIG. 12 by using the number N of black pixels included in the column and information M showing the positions where the black pixels exist. In the code word 76-2, 3 bits are allocated to a type code 82, 2 bits are allocated to the number of black pixels 84, and 3 bits are allocated to a black pixel position 86.

The value (the number of black pixels—1) is stored into 2 bits showing the number of black pixels 84. That is, in the case where the number of black pixels is equal to 1 pixel, 00 is stored. In the case where it is equal to 2 pixels, 01 is stored. In the case where it is equal to 3 pixels, 10 is stored. In the case where it is equal to 4 pixels, 11 is stored.

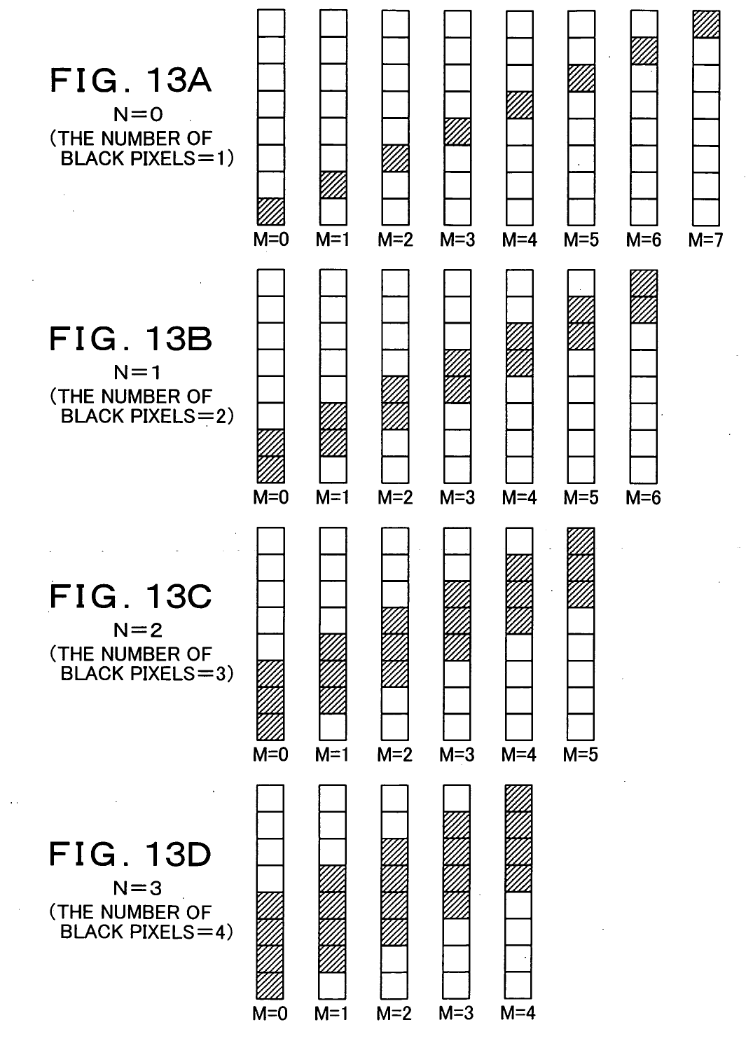

As shown in FIGS. 13A, 13B, 13C, and 13D, the value of M showing the positions of the black pixels of the 8-bit pattern in each of the cases where N=0, 1, 2, and 3 corresponding to the numbers of black pixels (1, 2, 3, and 4) is stored as a binary number into 3 bits showing the black pixel position 86. For example, in the case where the number of black pixels is equal to 1 in FIG. 13A, there are eight kinds (M=0 to M=7) positions of the black pixels. When they are expressed by binary numbers, one of the values 000 to 111 is stored.

In the cases where the number of black pixels is equal to or larger than 2 in FIGS. 13B, 13C, and 13D, values which are not used exist as codes showing the positions of the black pixels. However, they can be also used for another application such that it is used for the number of the reference pattern whose frequency of appearance is high as shown in the first embodiment, or the like.

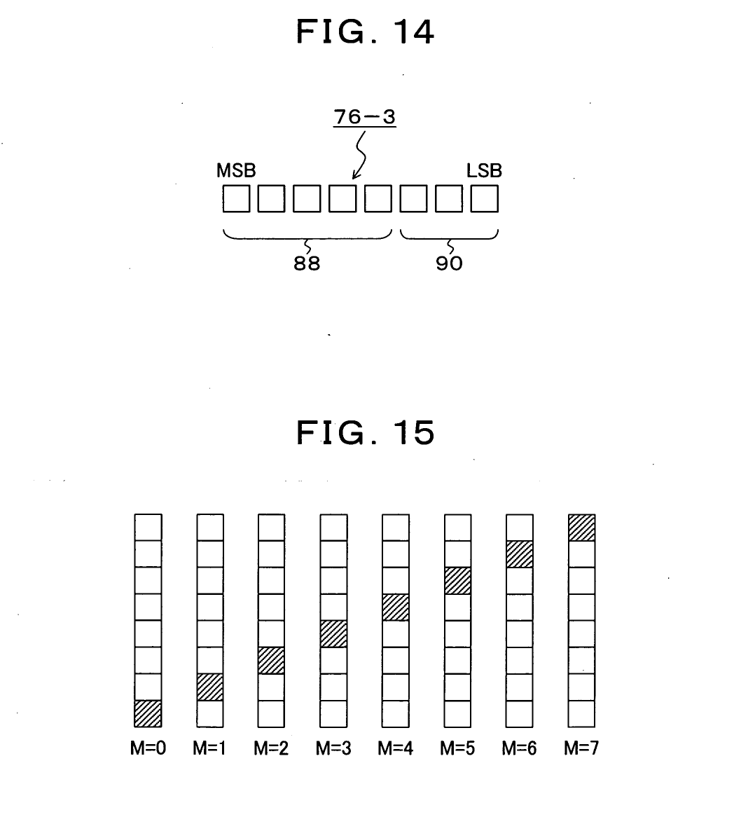

FIG. 14 shows another code word 76-3 to encode the non-compression area in which the number of columns is equal to 1 and the number of black pixels is equal to 1 by the image compressing process in the second embodiment of FIG. 11. In this example, 5 bits are allocated to a type code 88 and residual 3 bits are allocated to a black pixel position 90. That is, the code word 76-3 corresponds to the case where there is no room for the bits which are allocated to the number and positions of M continuous black pixels as shown in FIG. 12. The reference pattern is set by setting only the non-compression areas in which the number of black pixels is equal to 1 into targets as shown in FIG. 15, and the reference pattern is encoded only by the black pixel position 90.

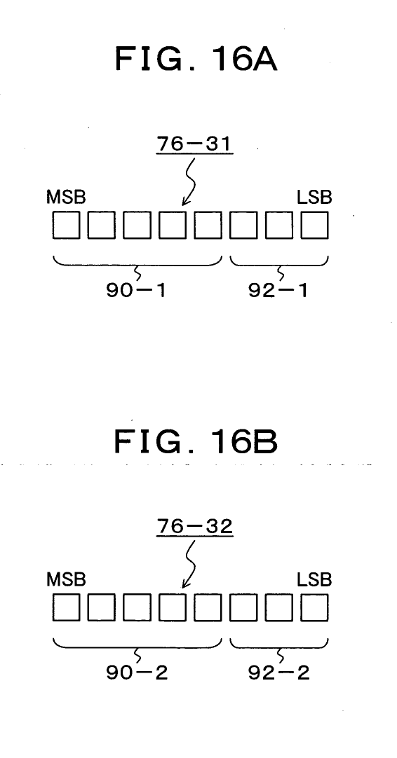

FIGS. 16A and 16B show examples of code words in which the compression ratio is further raised by applying the code word 76-3 in FIG. 14. In code words 76-31 and 76-32 in FIGS. 16A and 16B, 5 bits are allocated to a type code and 3 bits are allocated to a pixel position in a manner similar to the code word of FIG. 14.

However, in the code word 76-31 in FIG. 16A, the type code of 5 bits is set to a 1-black-pixel type code 90-1 and subsequent 3 bits are set to a black pixel position 92-1. In the code word 76-32 in FIG. 16B, head 5 bits are set to a 2-black-pixel type code 90-2 and subsequent 3 bits are set to a black pixel position 92-2.

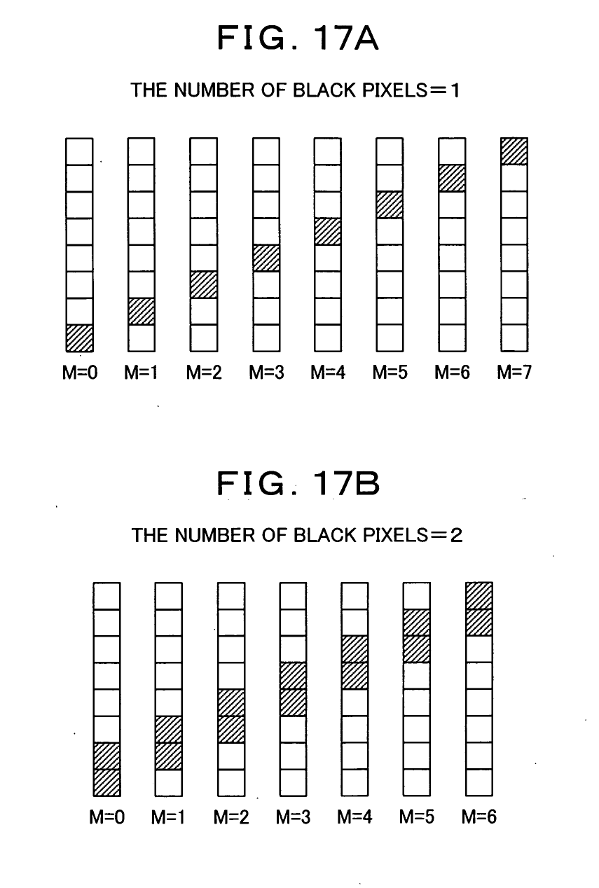

In correspondence to the code word 76-31 in FIG. 16A, eight kinds of reference patterns of M=0 to M=7 in which the black pixel positions in the columns in which the number of black pixels is equal to 1 in FIG. 17A are prepared. The numbers of the reference patterns which coincide with the black pixel position 92-1 are stored by a range of binary numbers 000 to 111.

In correspondence to the code word 76-32 in FIG. 16B, seven kinds of reference patterns of M=0 to M=6 in which the number of black pixels is equal to 2 in FIG. 17B are prepared. One of 000 to 111 corresponding to the reference pattern numbers M=0 to 6 is stored in the black pixel position 92-2.

By using the code word in which the black pixel position is combined with the type code corresponding to the number of continuous black pixels in the pattern in which the number of columns is equal to 1 as mentioned above, substantially the same encoding of the non-compression area as that of the code word 76-2 constructed by substantially the same type code 82, number of black pixels 84, and black pixel position 86 as those in FIG. 12 can be realized.

The invention provides a computer-readable storing medium which stores an image compressing program. As a recording medium for this purpose, in addition to a portable storing medium such as CD-ROM, floppy disk, DVD disk, magnetooptic disk, IC card, or the like and a storing apparatus such as hard disk, HDD, or the like provided inside or outside of a computer system, a database which holds the program via a line, or another computer system and its database, and further, a transmitting medium on the line are included.

In the above embodiments, first, as shown in FIG. 1A, the image is scanned in the vertical direction, separated into the areas including no black pixel and the areas including the black pixels, and encoded, and thereafter, the process according to the invention for encoding by using the reference pattern is executed with respect to the non-compression area which could not be encoded. However, on the contrary, it is also possible to execute the processes such that the non-compression areas in which the number of columns is equal to 1 are separated with respect to the areas including the black pixels separated by scanning the image in the vertical direction and the areas which coincide with the reference pattern are selected and encoded are executed and, thereafter, execute the process to select and encode the same column pattern, stairway-like pattern, or repetitive pattern as shown in FIG. 1B with respect to the residual non-compression areas. However, the invention is not applied to image data such that order is exchanged and the compression ratio is not improved.

In the embodiment of FIG. 1, each time the area is separated in each of the first area separating unit 18, second area separating unit 22, and third area separating unit 26, the encoding is executed. However, it is also possible to preliminarily execute the separating process and, after completion of the separating process, execute the encoding processes, in a lump, by the first encoding unit 20, second encoding unit 24, and further, third encoding unit 28 with respect to each of the separated areas.

The invention incorporates proper modifications without losing the objects and advantages of the invention. Further, the invention is not limited by the numerical values shown in the foregoing embodiments.

As described above, according to the invention, among the areas which do not correspond to the same column pattern, stairway-like pattern, or repetitive pattern and were outputted as codes as they are without being compressed, by encoding, particularly, the image of one column including the black pixels in which the frequency of appearance is high, the compression ratio can be raised.

For example, as for the image of the column 1 which is outputted as a code as it is without being compressed, by adding the code word showing the non-compression, the code data of 1 byte is changed to the code data of 2 bytes. According to the invention, however, by encoding the non-compression area whose frequency of appearance is high among the non-compression areas in which the number of columns is equal to 1, there is no need to add the code word showing the non-compression. It is sufficient to use only one byte according to the encoding. Thus, the compression ratio can be raised.

Consequently, a capacity of the code data of the print image which is transferred to the printer is reduced, a transferring time to the printer is shortened, and a print speed of the printer can be improved.

What is claimed is:

1. An image compressing method comprising:
a first area separating step wherein by scanning bit map data in a main scanning direction, the data is separated into an area including black pixels and an area including no black pixel on a unit basis of logic rows of a predetermined number as an integer of 1 or more by a first area separating unit;
a first encoding step wherein the area including no black pixel separated by said first area separating step is encoded as an element by a first encoding unit;
a second area separating step wherein by scanning the logic row including the black pixels separated by said first area separating step in a sub-scanning direction which crosses the main scanning direction, the data is separated into an area including the black pixels and an area including no black pixel on a column unit basis by a second area separating unit;
a second encoding step wherein the area including the black pixels which was separated by said second area separating step and in which the number of continuous columns is equal to or more than 2 is encoded as an element by a second encoding unit;
a third area separating step wherein an area which coincides with a predetermined reference pattern in which the number of columns is equal to 1 is separated by a third area separating unit from the areas which were not encoded in said second encoding step; and
a third encoding step wherein the area which coincides with said reference pattern and was separated by said third area separating step is encoded by a third encoding unit.

2. A method according to claim 1, wherein:
said reference pattern comprises a plurality of kinds of patterns of a predetermined number selected in order of the pattern whose frequency of appearance is high among the areas including the black pixels in which the number of columns is equal to 1 and which remain without being encoded by said second encoding step; and
in said third encoding step, the area including the black pixels in which the number of columns is equal to 1 and which was separated in said third area separating step is encoded by using a code showing a pattern number of the coincident reference pattern and a code showing a code type.

3. A method according to claim 2, wherein said reference pattern comprises a plurality of kinds of patterns of a predetermined number which have been selected in order of the pattern whose frequency of appearance is high with respect to the areas including the black pixels in which the number of columns is equal to 1 and have previously and statistically been obtained with respect to the area including the black pixels in which the number of columns is equal to 1 and which is separated in said third area separating step.

4. A method according to claim 1, wherein:
said reference pattern is a pattern in which one or a plurality of black pixels in one column are continuously included: and
in said third encoding step, the area including the black pixels in which the number of columns is equal to 1 and which was separated in said third area separating step is encoded by using a code showing positions of the black pixels in one column of the coincident reference pattern and the number of continuous black pixels and a code showing a code type.

5. A method according to claim 1, wherein:
said reference pattern is a pattern in which one black pixel in one column is included; and
in said third encoding step, the area including the black pixels in which the number of columns is equal to 1 and which was separated in said third area separating step is encoded by using a code showing positions of the black pixels in one column of the coincident reference pattern and a code showing a code type.

6. A method according to claim 1, wherein:
said reference pattern is a pattern in which one or a plurality of black pixels in one column are included; and
in said third encoding step, the area including the black pixels in which the number of columns is equal to 1 and which was separated in said third area separating step is encoded by using a code showing positions of the black pixels in one column and a code showing the number of continuous black pixels and a code type.

7. A method according to claim 1, wherein:
in said first encoding step, the area including no black pixel obtained in said first area separating step is encoded by the number of rows which are skipped; and
in said second encoding step, the area including no black pixel obtained in said second area separating step is encoded by the number of columns which are skipped, and the area including the black pixels of two or more continuous columns separated in said second area separating step is separated into a same column pattern, a stairway-like pattern, and a repetitive pattern and encoded, respectively.

8. An image compressing method comprising:
a first area separating step wherein by scanning bit map data in a main scanning direction, the data is separated into an area including black pixels and an area including no black pixel on a unit basis of logic rows of a predetermined number as an integer of 1 or more by a first area separating unit;
a second area separating step wherein by scanning the logic row including the black pixels separated by said first area separating step in a sub-scanning direction which crosses the main scanning direction, the data is separated into an area including black pixels and an area including no black pixel on a column unit basis by a second area separating unit;
a third area separating step wherein an area which coincides with a predetermined reference pattern in which the number of columns is equal to 1 is separated by a third area separating unit from the areas including the black pixels in which the number of columns is equal to 1 and which were separated in said second area separating step; and
an encoding step wherein each of the areas separated by said first to third area separating steps is encoded as an element by an encoding unit.

9. A program for allowing a computer to execute:
a first area separating step wherein by scanning bit map data in a main scanning direction, the data is separated into an area including black pixels and an area including no black pixel on a unit basis of logic rows of a predetermined number as an integer of 1 or more;
a first encoding step wherein the area including no black pixel separated by said first area separating step is encoded as an element;
a second area separating step wherein by scanning the logic row including the black pixels separated by said first area separating step in a sub-scanning direction which crosses the main scanning direction, the data is separated into an area including black pixels and an area including no black pixel on a column unit basis;
a second encoding step wherein the area including the black pixels which was separated by said second area separating step and in which the number of continuous columns is equal to or more than 2 is encoded as an element;
a third area separating step wherein an area which coincides with a predetermined reference pattern in which the number of columns is equal to 1 is separated from the areas which were not encoded in said second encoding step; and
a third encoding step wherein the area which coincides with said reference pattern and was separated by said third area separating step is encoded.

10. A program for allowing a computer to execute:
a first area separating step wherein by scanning bit map data in a main scanning direction, the data is separated into an area including black pixels and an area including no black pixel on a unit basis of logic rows of a predetermined number as an integer of 1 or more;
a second area separating step wherein by scanning the logic row including the black pixels separated by said first area separating step in a sub-scanning direction which crosses the main scanning direction, the data is separated into an area including black pixels and an area including no black pixel on a column unit basis;
a third area separating step wherein an area which coincides with a predetermined reference pattern in which the number of columns is equal to 1 is separated from the areas including the black pixels in which the number of columns is equal to 1 and which were separated in said second area separating step; and
an encoding step wherein each of the areas separated by said first to third area separating steps is encoded as an element.

11. A computer-readable recording medium which stores a program for allowing a computer to execute:
a first area separating step wherein by scanning bit map data in a main scanning direction, the data is separated into an area including black pixels and an area including no black pixel on a unit basis of logic rows of a predetermined number as an integer of 1 or more;
a first encoding step wherein the area including no black pixel separated by said first area separating step is encoded as an element;
a second area separating step wherein by scanning the logic row including the black pixels separated by said first area separating step in a sub-scanning direction which crosses the main scanning direction, the data is separated into an area including black pixels and an area including no black pixel on a column unit basis;
a second encoding step wherein the area including the black pixels which was separated by said second area separating step and in which the number of continuous columns is equal to or more than 2 is encoded as an element;
a third area separating step wherein an area which coincides with a predetermined reference pattern in which the number of columns is equal to 1 is separated from the areas which were not encoded in said second encoding step; and
a third encoding step wherein the area which coincides with said reference pattern and was separated by said third area separating step is encoded.

12. A computer-readable recording medium which stores a program for allowing a computer to execute:
a first area separating step wherein by scanning bit map data in a main scanning direction, the data is separated into an area including black pixels and an area including no black pixel on a unit basis of logic rows of a predetermined number as an integer of 1 or more;
a second area separating step wherein by scanning the logic row including the black pixels separated by said first area separating step in a sub-scanning direction which crosses the main scanning direction, the data is separated into an area including black pixels and an area including no black pixel on a column unit basis;
a third area separating step wherein an area which coincides with a predetermined reference pattern in which the number of columns is equal to 1 is separated from the areas including the black pixels in which the number of columns is equal to 1 and which were separated in said second area separating step; and
an encoding step wherein each of the areas separated by said first to third area separating steps is encoded as an element.

13. An image compressing apparatus comprising:
a first area separating unit which scans bit map data in a main scanning direction, thereby separating the data into an area including black pixels and an area including no black pixel on a unit basis of logic rows of a predetermined number as an integer of 1 or more;
a first encoding unit which encodes the area including no black pixel separated by said first area separating unit as an element;
a second area separating unit which scans the logic row including the black pixels separated by said first area separating unit in a sub-scanning direction which crosses the main scanning direction, thereby separating the data into an area including black pixels and an area including no black pixel on a column unit basis;
a second encoding unit which encodes the area, as an element, including the black pixels which was separated by said second area separating unit and in which the number of continuous columns is equal to or more than 2;
a third area separating unit which separates an area which coincides with a predetermined reference pattern in which the number of columns is equal to 1 from the areas which were not encoded by said second encoding unit; and
a third encoding unit which encodes the area which coincides with said reference pattern and was separated by said third area separating unit.

14. An image compressing apparatus comprising:
a first area separating unit which scans bit map data in a main scanning direction, thereby separating the data into an area including black pixels and an area including no black pixel on a unit basis of logic rows of a predetermined number as an integer of 1 or more;
a second area separating unit which scans the logic row including the black pixels separated by said first area separating unit in a sub-scanning direction which crosses the main scanning direction, thereby separating the data into an area including black pixels and an area including no black pixel on a column unit basis;
a third area separating unit which separates an area which coincides with a predetermined reference pattern in which the number of columns is equal to 1 from the areas including the black pixels in which the number of columns is equal to 1 and which were separated by said second area separating unit; and
an encoding unit which encodes each of the areas separated by said first to third area separating units as an element.
